(19) United States
(12) Patent Application Publication
(10) Pub. No.: US 2024/0296508 A1
(43) Pub. Date: Sep. 5, 2024

(54) METHOD AND SYSTEM FOR HANDLING FOOD INGREDIENTS THAT ARE ASSOCIATED WITH AN AUTOMATED COOKING RESTAURANT (ACR)

(71) Applicant: KITCHEN ROBOTICS LTD, Modiin (IL)

(72) Inventors: Yair GORDIN, Modiin (IL); David BEN-DAVID, Rehovot (IL)

(73) Assignee: KITCHEN ROBOTICS LTD, Modiin (IL)

(21) Appl. No.: 18/661,847

(22) Filed: May 13, 2024

Related U.S. Application Data
(63) Continuation-in-part of application No. 17/663,895, filed on May 18, 2022.
(63) Continuation-in-part of application No. 17/806,948, filed on Jun. 15, 2022.
(63) Continuation-in-part of application No. 17/448,898, filed on Sep. 27, 2021, now abandoned.
(63) Continuation-in-part of application No. 18/108,635, filed on Feb. 12, 2023.

(51) Int. Cl. G06Q 50/12; G06K 7/10; G06K 17/00; G06K 19/07

(52) U.S. Cl. CPC G06Q 50/12; G06K 7/10297; G06K 17/0025; G06K 19/0723

(57) ABSTRACT

A novel food-ingredients-preparation-workstation (FIPW) that is associated with an automated-cooking-restaurant (ACR). The ACR controller is configured to control the operation of an ACR that is located at an ACR-site. The FIPW comprises an RFID read/write device that is configured to write information into an RFID tag that is associated with a food-ingredient-cartridge (FIC), and to read information from that RFID tag. A dispenser controller is configured to control the operation of a dispenser of food ingredients.

### CROSS-REFERENCE TO RELATED APPLICATIONS

This utility patent application is a continuation-in-part of the United States non-provisional application for patent that was filed on May 18, 2022, and assigned the Ser. No. 17/663,895, and this utility patent application is also a continuation-in-part of United States non-provisional application for patent that was filed on Jun. 15, 2022, and assigned the Ser. No. 17/806,948, and this utility patent application is also a continuation-in-part of United States non-provisional application for patent that was filed on Sep. 27, 2021, and assigned the Ser. No. 17/448,898, and this utility patent application is also a continuation-in-part of United States non-provisional application for patent that was filed on Feb. 12, 2023, and assigned the Ser. No. 18/108,635, and this utility patent application is also related to a U.S. Pat. No. 11,957,278 filed on Dec. 14, 2007, which application has expired. The contents of each of the afore-mentioned US Patent Applications are hereby incorporated herein by reference.

### FIELD OF THE DISCLOSURE

The present disclosure relates to the field of an automated-cooking-restaurant (ACR) and more particularly the disclosure relates to a technique for handling food ingredients to be used by the ACR, wherein the technique is using one or more Radio-frequency identification (RFID) tags.

### BACKGROUND

A common automated-cooking-restaurant (ACR) is associated with a dispenser. The dispenser may comprise a plurality of food ingredient dispenser units (DiUs). Each DiU may comprise food-ingredient-cartridges (FICs) and a conveying-mechanism (CoM) unit. An example of FIC may comprise a container and two covers, a top cover and a bottom cover. The top of the container and the bottom of container may have slots through which the top cover and the bottom cover can be pushed in order to close the food ingredients in the FIC.

A common FIC is configured to handle a plurality types of food ingredients. Food ingredients such as but not limited to meat, sugar, salt vegetables, rice, pasta, peanuts, etc. The food ingredients are prepared according to a pre-assigned menu to be cooked today. The food ingredients may have different sizes. Each type of food ingredient can be placed in an FIC. The operator, who prepares the ingredient to be matched the requirements of the menu, puts the ingredients in a FIC. The preparation may comprise washing, cutting to appropriate size and shape, etc. Finally the operator may write on the FIC the type of the ingredients that is located in that FIC.

Before placing a ready to be used FIC in the dispenser a CoM has to be associated with that FIC. The CoM has to match the type of the food ingredients that is located in that FIC. In cases that the CoM comprises a screw conveyor or auger conveyor the pitch of the screw needs to match the food ingredient. Olives or tomatoes may be dispensed by a coarse auger, for example. Powdered food ingredient such as flour, sugar, salt, etc may be dispensed by a fine auger, for example. In the following description and claims, the words screw, auger, CoM may be used interchangeably.

Further, some of the ingredients have to be cooked in temperature which is higher than a certain threshold. Chicken has to be cooked above 80 degrees Celsius, for example. Some ingredients have expiration date. Other ingredients comprise allergen. There are cases in which an operator, by mistake, associates a CoM to a FIC wherein the CoM does not meet the needs of the food ingredient, which is in that FIC. There are dishes in which the cooking cycle does not meet the requirement of the food ingredients that located in a certain FIC. The cooking temperature is below the requirements, for example.

Further, since the ACR prepares food it has to comply with regulations that are related to food manufactures such as but not limited to the National-Sanitation-Foundation-International (NSF-International) or FDA food code, etc. Among a plurality of requirements the regulations defines cleaning procedure, thus it is important that the FIC will be cleaned properly before loading it with food ingredients. From the same reason the CoM has to be cleaned before associating it with a full FIC.

### BRIEF SUMMARY

The needs and the deficiencies that are described above are not intended to limit the scope of the inventive concepts of the present disclosure in any manner. The needs are presented for illustration only. The disclosure is directed to a novel technique for handling food ingredients in an environment of an ACR. From the current situation we learn that a lot of information is associated with decisions that have to be taken by an operator of an ACR. In order to support the operator and to reduce mistakes an RFID tag can be embedded in each FIC and in each CoM. An example of RFID tag can be such as but not limited to Tiny XXS AH3 or Tiny-XS manufactured by Global-Tag. Global-Tag is an Italian company. The RFID tag of an example CoM may store information about the pitch of the CoS, whether it is clean or not, etc.

An example embodiment of the disclosed technique may comprise a food-ingredients-preparation-workstation (FIPW). An example of FIPW may comprise a processor, non-transitory computer readable storage device, and an RFID read/write device. The term processor can refer to a computer such as but not limited to ADVANTEC AMAX-5580 IPC or Intel NUC, wherein NUC stands for Next-Unit-of-Computing or “Amazon EC2 A1 Instances” or “Amazon EC2 P3 Instances”, which are maintained by Amazon Crop USA, or other programmable data processing apparatus. The computer readable storage device can be such as but not limited to a read/write solid-state disc (SSD), CDROM, Flash memory, ROM, or other non-transitory computer readable storage device.

The RFID read/write device can be MF1S7030X/V1 manufactured by NXP Semiconductors, a Dutch company. Examples of RFID read/write device can transmit/receive signals at frequencies at HF band, UHF band, at 13.56 Mhz, etc. The frequency has to match the frequency that is used by the RFID tag.

An example of the FIPW may be configured to obtain a list of ingredients to be used today. Per each ingredient the processor of the FIPW may fetch instruction how to handle the ingredient and accordingly instructs the operator. The instructions may comprise washing instruction, cutting instruction, shaping instructions warming/cooling instructions, etc. After putting the ingredient in an FIC the operator can be prompted to close the FIC and place it near an RFID read/write device. In some example embodiments, the operator may be prompted to add information such as but not limited to the weight of the ingredients, expiration date, etc. Next, the FIPW may write relevant features of that ingredient to the RFID tag that is embedded in the FIC. The features may comprise ingredient type, size, shape, quantity, expiration date, allergens, allowable temperature range, etc.

In some example embodiments, the FIPW can be associated with one or more of the following instruments: a digital weight meter, an ultrasonic sensor for measuring volume, a digital camera, and a thermal imaging camera. The information from those devices will be written in the RFID tag.

Some example embodiments of the disclosed technique may write just an ID for that FIC in the RFID tag. In such embodiment the ID can be used as a pointer to an address in a non-transitory computer readable storage device Of the FIPW. In such embodiment the FIPW may store the data in that address and not in the RFID tag.

At this point the FIPW may instruct the operator to associate the FIC with an appropriate CoM. The CoM has to fit the ingredient that is located in that FIC. By using the RFID read/write device the processor of the FIPW may read the type of the ingredient and the pitch of the CoM and may determine whether the CoM match the ingredient or the CoM has to be replaced. If the FIC and the CoM are matched, then the combined unit can be referred as DiU. The DiU can be placed in a certain location of the dispenser. In cases in which the RFID tag indicates that the food ingredients that are located in that DiU contain allergen the controller of the FIPW may instruct the operator to put that DiU in a lower row of the dispenser.

An example of CoM may comprise four types of augers. Auger type A may have large pitch (5 cm, for example) and can be used for handling big slices of meat, chicken, a complete potato, complete tomato, etc. Auger type B may have pitch at medium size (3 cm, for example) and can be used for handling slices of potato, slices of tomato, etc. Auger type C may have a small pitch (2 cm, for example) and can be used for handling beans such as but not limited to peas, humus, etc. Auger type D may have a fine pitch (1 cm, for example) and can be used for handling powders such as but not limited to sugar, salt, etc.

A reader who wishes to learn more about the FIC, QoM and the dispenser is invited to read U.S. applications for patent Ser. Nos. 17/663,895, 17/448,898 and 18/108,635, and a U.S. Pat. No. 11,957,278. The contents of which are incorporated herein by reference.

An example embodiment of a food-ingredients-preparation-workstation (FIPW) can be configured to obtain a list of ingredients (LoI) from the associated ACR. After obtaining the LoI the FIPW may start the preparation stage. It may instruct the operator to fetch a clean and empty FIC and to read its RFID. After reading the RFID, which is associated with the FIC, the FIPW may determine that the FIC is clean and can be used for containing the first ingredient.

By using the LoI the operator may fill a first food-ingredient-cartridge (FIC) with the first ingredient that is written in the list and may instruct the FIPW to update the information that is stored in the RFID that is associated with that FIC with information that is related to the relevant ingredient. Information such as the type of ingredient, size, shape, quantity, expiration date, allergens, allowable temperature range, etc.

The LoI may comprise information about the type of the required CoM. Thus, the FIPW may instruct the operator to associate the appropriate CoM to the FIC. Next, the operator can be instructed to read the RFID that is associated with the FIC and the RFID that is associated with the CoM and the FIPW may determine whether the CoM matches the needs of the relevant food ingredient. If no, the operator can be prompted to replace the CoM. If the CoM matches the needs of the relevant food ingredient, which means that the set is a ready to be used DiU and the operator can be instructed to put the ready to be used DiU in a certain location in the dispenser. Other example embodiment may instruct the operator to put the DiU in the dispenser and then to update the ACR about the location of that DiU.

A dispenser that is associated with an ACR comprises a collecting apparatus. The collecting apparatus is equipped with a moving mechanism (MM), an ingredient-collecting-vessel (ICV) and a holding mechanism that holds the ICV. An example of a holding mechanism can be associated with an RFID reader. In such embodiments of a dispenser, the controller of the dispenser, which is aware of the recipe of the current dish, can be configured to read the RFID tag that is associated with an FIC that is associated with the holding mechanism. The FIC from which the food ingredients will be collected.

Next, the controller of the dispenser may compare the features of the ingredient, which were obtained from the RFID tag, with the dish preparation instruction in order to determine whether the relevant food ingredients will not be damaged during the cooking process. Moreover, it may determine whether the cooking instructions do not comply with the regulations that are related to food manufactures such as but not limited to the National-Sanitation-Foundation-International (NSF-International) or the FDA food code, etc. Then, the controller may inform the operator and may prompt the operator to check whether some parameters of the cooking process can be changed. The preparation instructions can be associated with the recipe.

In addition the expiration date of those food ingredients can be compared to the current date and a decision can be made whether the date has been expired. If yes, then the controller of the dispenser may instruct the operator to replace the food ingredients with fresh ingredients.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Further, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Some examples of embodiments of the present disclosure will be understood and appreciated more fully from the following detailed description, taken in conjunction with the drawings in which:

FIG. 1 schematically illustrates a block diagram with relevant elements of an example of a Food-Ingredients-Preparation Workstation (FIPW);

FIG. 2 illustrates a flowchart with relevant actions that can be implemented by an example of FIPW in order to load a dispenser; and

FIG. 3 illustrates a flowchart with relevant actions of an example process that can be implemented by a control module of an Ingredient-collecting-Zone (ICZ), a control task of a dispenser.

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labeled with numerals.

The purpose of the drawings is to describe examples of embodiments and not for production purpose. Therefore, features shown in the figures are chosen for convenience and clarity of presentation only. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description and claims, the words “unit,” “element,” “module”, and “logical module” may be used interchangeably. Anything designated as a unit or module may be a stand-alone unit or a specialized or integrated module. A unit or a module may be modular or have modular aspects allowing it to be easily removed and replaced with another similar unit or module. In addition the terms element and section can be used interchangeably. In the following description and claims, the words “course,” “dish”, and “meal” may be used interchangeably.

Each unit or module may be any one of, or any combination of, software, hardware, and/or firmware, ultimately resulting in one or more processors programmed to execute the functionality ascribed to the unit or module. Additionally, multiple modules of the same or different types may be implemented by a single processor. As used herein, the term ‘processor’ can refer to a computer such as but not limited to ADVANTEC AMAX-5580 IPC or to Intel NUC, wherein NUC stands for Next-Unit-of-Computing or “Amazon EC2 A1 Instances” or “Amazon EC2 P3 Instances”, which are maintained by Amazon Crop USA, for example. Other example embodiments of the disclosed technique may use cloud resources as processors, servers, non-transitory computer readable storage devices, etc.

Software of a logical module may be embodied on a computer readable storage device such as but not limited to a read/write solid-state disc (SSD), CDROM, Flash memory, ROM, or other non-transitory computer readable storage device. In order to execute a certain task a software program may be loaded to an appropriate processor as needed. In the present disclosure the terms task, method, process can be used interchangeably. In the present disclosure the verbs transmit, transfer or be placed in a queue can be used interchangeably.

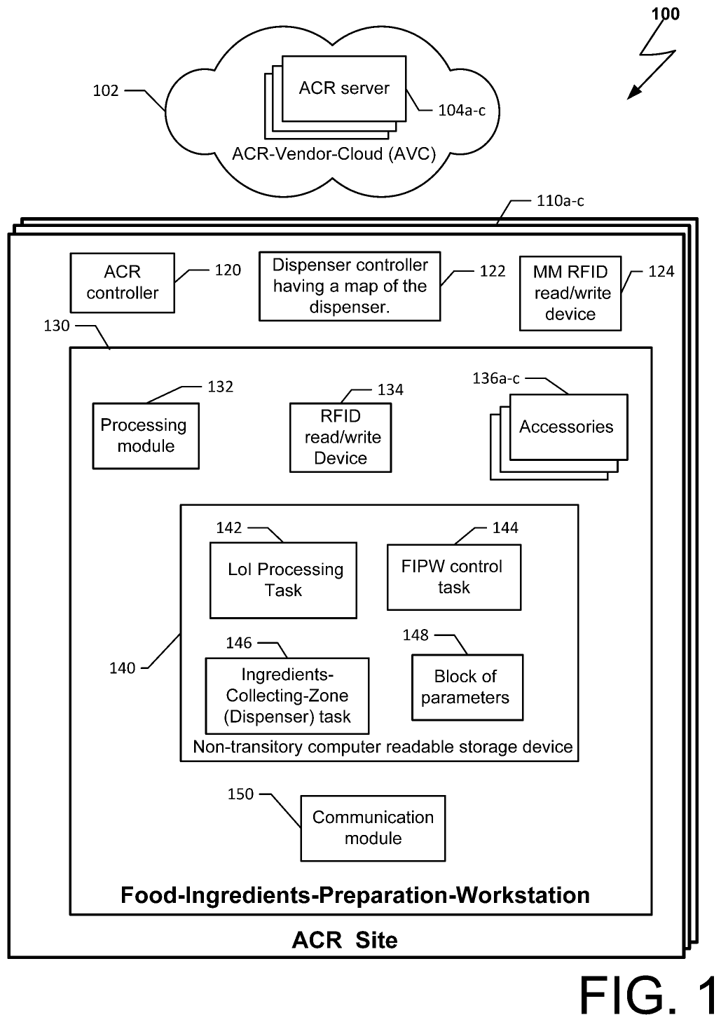

FIG. 1 schematically illustrates a block diagram with relevant elements of an example of an ACR system (ACRS) 100. Example embodiments of ACRS 100 may comprise an ACR-Vendor-Cloud (AVC) 102 and one or more ACR sites 110a-c. An example of AVC 102 may comprise one or more ACR servers 104a-c. ACR servers 104a-c may comprise information that is related to dishes that can be prepared at the ACR sites 110a-c. Information such as but not limited to ingredients, menus, recipes, preparation instructions, features of the ingredients, etc. ACR servers 104a-c can communicate with one or more ACR sites 110a-c. The communication can be based on Internet Protocol (IP), HTTPS, TELNET, etc. Those communication protocols are well known to a person having an ordinary skill in the art and will not be further disclosed.

An example of an ACR site 110a-c may comprise: an ACR-controller 120; a dispenser controller 122 having a map of the dispenser and a food-ingredients-preparation-workstation (FIPW) 130; and an MM RFID read/write device 124 that is associated with the MM of the dispenser. Each controller, 120 or 122, may comprise a processing unit and a non-transitory computer readable storage devices. The processing unit can be ADVANTEC AMAX-5580 IPC or Intel NUC, wherein NUC stands for Next-Unit-of-Computing or “Amazon EC2 A1 Instances” or “Amazon EC2 P3 Instances”, which are maintained by Amazon Crop USA, or other programmable data processing apparatus. The non-transitory computer readable storage devices can be such as but not limited to a read/write solid-state disc (SSD), CDROM, Flash memory, ROM, or other non-transitory computer readable storage device. In order to execute a certain task a software program may be loaded from the non-transitory computer readable storage device to the ACR controller 120 or the dispenser controller 122.

An example of RFID read/write device 124 can be MF1S70yyX/V1 manufactured by NXP Semiconductors N.V. (NXP), which is a Dutch company. Examples of RFID read/write device 124 can transmit/receive signals at frequencies at HF band, UHF band, at 13.56 Mhz, etc. The frequency has to match the frequency that is used by the RFID tag.

The ACR controller 120 may be configured to control the preparation of a dish according to a recipe that was obtained from one of the ACR servers 104a-c. An example of ACR controller 120 may control the temperature of the cooking, the duration of the cooking, the handling of a cooking device while it is associated with the ACR, etc. An example of a cooking device can be such as but not limited a pot, a vessel, etc. In the following description and claims, the term pot may be used as a representative term of a cooking device.

An example of a Dispenser controller 122 may have a map of the current ingredients-collecting-zone (ICZ). The map indicates the location of each FIC in the ICZ. The dispenser controller 122 can be configured to obtain a LoI of a certain dish, wherein the LoI comprises the RFID tag that is associated with the FIC of each ingredient. According to the LoI, the map of the ICZ, and the RFID tag the dispenser controller 122 may instruct an MM to associated the ICV with a relevant FIC in order to add it's ingredients into the ICV. In some embodiments the MM can be associated with an RFID reader, which can confirm that the FIC is the appropriate FIC that comprises the appropriate food ingredient. An example of MM can be a robotic-arm (not shown in the figures).

In some example embodiments of the disclosed technique the dispenser controller 122 may compare the features of the collected ingredient, which were obtained from the RFID tag, with the dish preparation instruction in order to determine whether the relevant food ingredients will not be damaged during the cooking process. Moreover, the dispenser controller 122 may determine whether the cooking instructions do not comply with the regulations that are related to food manufactures such as but not limited to the National-Sanitation-Foundation-International (NSF-International) or the FDA food code, etc. Those regulations can be fetched from one of the ACR servers 104a-c.

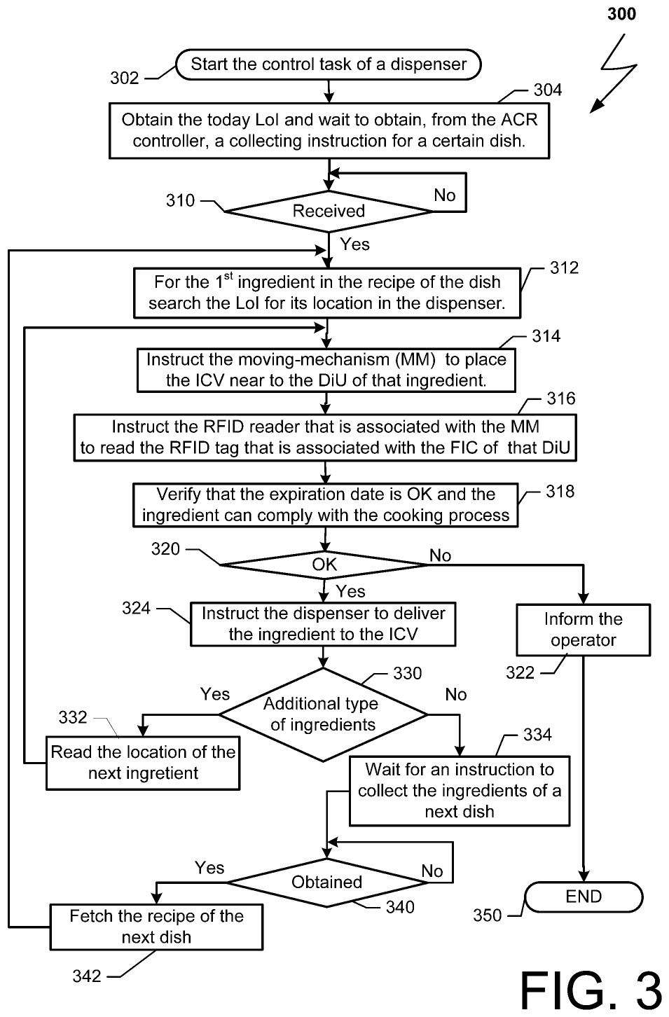

In cases wherein the cooking instructions do not comply with the regulations, the dispenser controller 122 may inform the operator and may prompt the operator to check whether some parameters of the cooking process can be changed. The preparation instructions can be associated with the recipe. More information on the operation of the dispenser controller 122 is disclosed below in conjunction with FIG. 3.

An example of a food-ingredients-preparation-workstation (FIPW) 130 may comprise a processing module 132, an RFID read/write device 134, one or more accessories 136a-c, a non-transitory-computer-readable-storage-device 140 and a communication module 150. The one or more accessories 136a-c may comprise a digital weight meter, an ultrasonic sensor for measuring volume, a digital camera, and a thermal imaging camera, etc. Those devices can be configured to communicate with the processing module 132 in order to deliver information about the food ingredients that are enclosed in the ICV.

An example of RFID read/write device 134 can be ST25 NFC/RFID Reader manufactured by STMicroelectronics. Another example can be MF1S70yyX/V1 manufactured by NXP Semiconductors N.V. (NXP), which is a Dutch company. Examples of RFID read/write device 134 can transmit/receive signals at frequencies at HF band, UHF band, at 13.56 Mhz, etc. The frequency has to match the frequency that is used by the RFID tag.

The communication between the processing module 132 and the one or more accessories 136a-c, the ACR controller 120, the RFID read/write device 134, and the dispenser controller 122 may be done via communication module 150 over a Bluetooth network, for example. Bluetooth is a short-range wireless technology that is well known to a person having an ordinary skill in the art and will not be further disclosed. Other example embodiments may use serial cable, network cable, etc.

An example of a non-transitory-computer-readable-storage-device 140 may store one or more software programs that when are loaded to the processing module 132, the processing module 132 may execute a certain task. For example, block 142 comprises a software code that may instruct the processing module 132 to obtain a LoI to be used today. Per each ingredient in the LoI the processing module 132 can be instructed to look for parameters that are related to that ingredient. The parameters may include ingredient type, cutting size, shape, quantity, expiration date, allergens, allowable temperature range, washing instructions, RFID tag information of the FIC, RFID tag information of the CoM, etc. Those parameters can be stored in the block of parameters 148. In some example embodiments those parameters can be added to the today LoI.

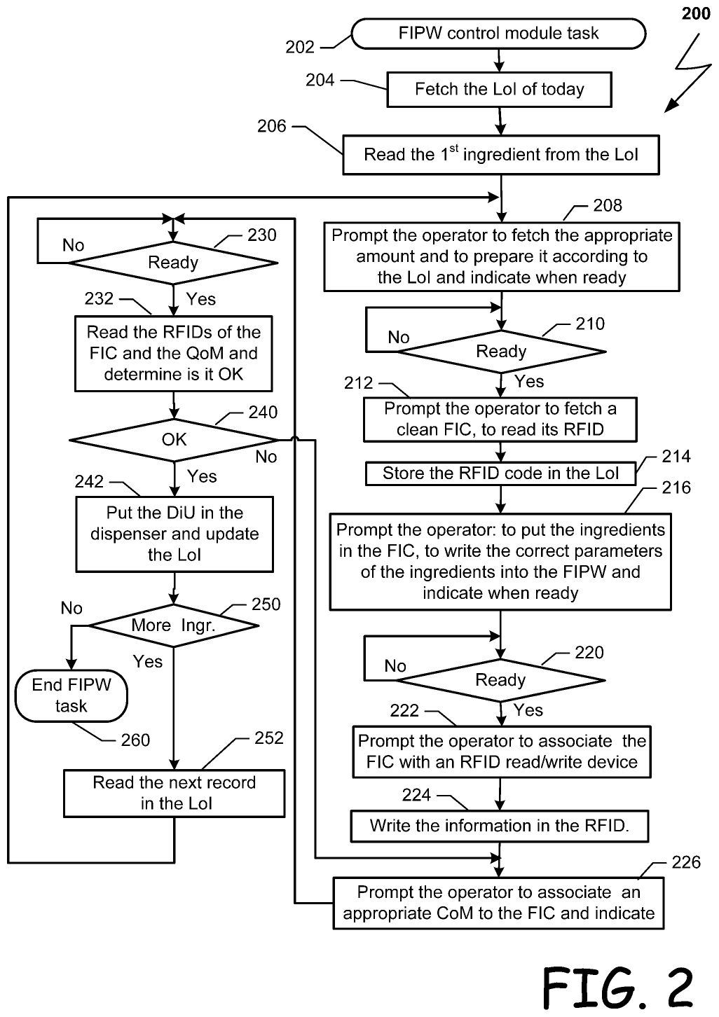

Block 144 may comprise a software code that when is loaded to the processing module 132, the processing module 132 may lead an operator how to prepare the food ingredients while the operator is working in the FIPW. More information about the FIPW task 144 is disclosed below in conjunction with FIG. 2. Block 146 may comprise a software code that when is loaded to the processing module 132, the processing module 132 may control the operation of the dispenser. More information about the dispenser controlling task 146 is disclosed below in conjunction with FIG. 3.

FIG. 2 illustrates a flowchart with relevant actions that can be implemented by an example process 200. Process 200 can be implemented by processing-module 132 (FIG. 1) of an example of FIPW 130 in order to load a dispenser. Process 200 can be initiated 202 by an operator of the FIPW in order to start collecting the ingredients for loading the dispenser. At block 204 the today LoI is obtained from one of the ACR servers 104a-c (FIG. 1). Each record in the LoI comprises the type of ingredient, amount, preparation instructions, features of the ingredient, etc. The features may comprise ingredient type, size, shape, quantity, expiration date, allergens, allowable temperature range, etc.

At block 208 process 200 may prompt the operator to fetch the appropriate amount of the ingredient and to prepare it according to the recipe of that dish and to indicating that the ingredient is ready. The preparation may comprise: washing instructions, cutting the ingredient to the required size and shape, warming/cooling instructions, etc. At the end of preparing that ingredient the operator is requested to indicate that the ingredient is ready.

Next process 200 may wait 210 until receiving the indication the ingredient is ready. The ready indication can be obtained from a keyboard that is associated with the FIPW. After obtaining the indication, process 200 may prompt 212 the operator to fetch a clean FIC and to associate it with the RFID read/write device 134 (FIG. 1) in order to read its RFID tag. The information from the RFID tag, which is the ID of that tag, can be stored 214 in the LoI in the relevant record.

At block 216 the operator can be prompt to put the prepared ingredients in the FIC and to indicate when it was done. Then process 200 may wait 220 until getting the ready indication. Upon getting 220 the ready indication, the operator can be prompted to associated the FIC with the RFID read/write device 134 (FIG. 1) in order to write 224 the appropriate information to the RFID tag. The information may comprise the features of the prepared ingredient. The features can be ingredient type, size, shape, quantity, expiration date, allergens, allowable temperature range, etc. Other example embodiments of the disclosed technique may store the information in a memory device of the FIPW and use the ID from the RFID tag as a pointer to the address in the memory device in which the information is stored.

Next, the operator can be prompted 226 to associate an appropriate CoM to the FIC, in order to generate a DiU, and to indicate when the DiU is ready. When 230 it is ready the DiU can be associated with the RFID read/write device 134 (FIG. 1) in order to read the RFID tag of the FIC and the RFID tag of the CoM and process 200 may check 232 whether the CoM matches the needs of the ingredient that is located in the FIC. Whether the pitch of the auger of that CoM matches the size of the ingredient, for example. If 240 they are not matched, then process 200 returns to block 226 and prompts the operator to associate an appropriate CoM.

If 240 the CoM matches the needs of the ingredient, then the operator can be prompted to put 242 the DiU in the dispenser. In some example embodiments the operator decides in which location, at the dispenser, to put the DiU, in such a case the operator needs to update the LoI 242. In other example embodiments of the disclosed technique process 200 may define the location, in such a case there is no need to update the LoI.

Next, a decision is made 250 whether there are more ingredients in the today LoI. If 250 there are more ingredients, then at block 252 the next record, in the LoI, is read and process 200 returns to block 208. If there are no additional ingredients, then process 250 can be terminated 260.

Referring now to FIG. 3 that illustrates a flowchart with relevant actions that can be implemented by an example process 300. Process 300 can be implemented by a controller 122 (FIG. 1) of a dispenser of an example of ACR site 110a-c (FIG. 1). Process 300 can be used for collecting food ingredients, which are needed in order to prepare a current dish, into an ICV. Process 300 can be initiated 302 upon initiating the relevant ACR site 110a-c. (FIG. 1).

After initiation, process 300 may obtain 304 the today LoI from one of the ACR servers 104a-c (FIG. 1). Then process 300 may wait 310 to obtain a collecting instruction for a certain dish. The collecting instruction may be received from the ACR controller 120 (FIG. 1). Upon receiving 310 the collecting instruction for the ingredients of a certain dish, process 300 may fetch 312 the recipe of that dish. Next, the today LoI can be search for a record that is related to a first ingredient in that recipe. From that record the location of the first ingredient, in the dispenser, is obtained.

Then, process 300 may instruct the MM of the dispenser to place 314 it's associated ICV near to the DiU, which contains that ingredient. At block 316 the RFID reader that is associated with the MM is instructed to read the RFID tag that is associated with the FIC of that DiU.

At block 318 process 300 may verify whether the features of the ingredients, which are stored in the relevant FIC, comply with the needs of the recipe. The features can be read from the RFID tag that is associated with the FIC. In another example embodiment of the disclosed technique, the features can be read from memory device 140 (FIG. 1) from an address that is pointed by the RFID tag. Features such as but not limited to expiration date, allowable temperature range, sizes, etc. If 320 the ingredients comply with the requirements, then process 300 may proceed to block 324. If 320, the ingredients do not comply with the requirements, then an operator can be informed 322 about the problem and process 300 may be terminated 350.

At block 324 process 300 may instruct the dispenser to deliver the ingredients to the ICV and a decision is made 330 whether the recipe comprise additional type of ingredient. If 330 yes, then the location in the dispenser of the next ingredient in the recipe is read 332 from the LoI and process 300 returns to block 314.

If 330 there is no additional type of ingredient in the recipe, then process 300 may wait 334 to obtain a collecting instruction of ingredients of a next dish. Upon 340 obtaining the collecting instruction, the recipe of the next dish is fetched 342 and process 300 returns to block 312 for collecting the first ingredient of the next dish.

In the description and claims of the present disclosure, each of the verbs, “comprise”, “include”, “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

What is claimed is:

1. A system that is installed at an automated-cooking-restaurant (ACR) site, the system comprising:
an ACR controller that is configured to control the operation of an ACR that is located in the ACR-site;
a dispenser controller that is configured to control the operation of a dispenser of food ingredients, wherein the dispenser is located in the ACR-site; and
a food-ingredients-preparation-workstation (FIPW), wherein the FIPW is associated with an RFID read/write device that is configured to write information into an RFID tag that is associated with a food-ingredient-cartridge (FIC), and to read information from that RFID tag.

2. The system of claim 1, wherein the information that is written in the RFID tag comprises at least one parameter from the group consisting of ingredient type, size, shape, amount, expiration date, allowable temperature range, and washing instructions of the FIC.

3. The system of claim 1, wherein the information that is written in the RFID tag is a pointer to an address in a non-transitory computer readable storage device that stores at least one parameter from the group consisting of ingredient type, size, shape, amount, expiration date, allowable temperature range, and washing instructions of the FIC.

4. The system of claim 1, further comprising a moving mechanism (MM), which is associated with the dispenser, for moving an ingredient-collecting-vessel (ICV) along the dispenser.

5. The system of claim 4, wherein the MM is associated with an RFID reader for reading an RFID tag that is associated with an FIC that is located in the dispenser.

6. The system of claim 4, wherein the MM is associated with an RFID write/read for reading information from an RFID tag that is associated with an FIC that is located in the dispenser and to write updated information into that RFID tag.

7. The system of claim 1, wherein the FIPW further comprising a processing module and a non-transitory computer readable storage device comprising instructions that when are executed by the processing module cause the processing module to instruct an operator:
a. to prepare an ingredient according to a list-of-ingredients (LoI) and convert it into a prepared-ingredient;
b. to place the prepared-ingredient in an FIC;
c. to associate the FIC with the RFID read/write device of the FIPW for writing information about the prepared-ingredient into the RFID tag;
d. to associate a certain conveying-mechanism (CoM) to the FIC that has the prepared-ingredient for generating a dispenser unit (DiU);
e. to associate the DiU with the RFID read/write device to read the RFID tag of the FIC and the RFID tag of the CoM and determine whether the CoM matches the requirements of the prepared-ingredients that are placed in the FIC and if the CoM matches the needs of the prepared-ingredients, then instruct the operator to place the DiU in the dispenser; if not instruct the operator to return to block (d) and replace the CoM.

8. The system of claim 7, wherein the information about the prepared-ingredient that is written in the RFID tag of the FIC comprises at least one parameter from the group consisting of ingredient type, size, shape, amount, expiration date, allowable temperature range, and washing information.

9. The system of claim 7, wherein the CoM matches the size of the prepared-ingredient.

10. The system of claim 5, wherein the dispenser-controller is configured:
a. to obtain a collecting instruction for a certain dish;
b. to instruct the MM to place the ICV near an FIC that comprises food-ingredients that are needed to prepare the certain dish;
c. to instruct the RFID reader that is associated with the MM to read the RFID tag that is associated with the FIC; and
d. to determine whether the food-ingredients that are associated with that FIC comply with the cooking instruction of the certain dish, if yes then proceed to a next food-ingredient, if not alert an operator.

11. The system of claim 6, wherein the dispenser-controller is configured:
a. to obtain a collecting instruction for a certain dish;
b. to instruct the MM to place the ICV near an FIC that comprises food-ingredients that are needed to prepare the certain dish;
c. to instruct the RFID read/write device that is associated with the MM to read the RFID tag the is associated with the FIC; and
d. to determine whether the food-ingredients that are associated with that FIC comply with the cooking instruction of the certain dish, if yes then proceed to a next food-ingredient, if not inform alert an operator.

12. The system of claim 10 or 11, wherein the cooking instruction comprises at least one instruction from the group consisting of: to check the expiration date, to cook the dish in a temperature in a certain range, and to cook the dish during a certain period of time.

13. The system of claim 1, wherein the RFID tag is Tiny XXS AH3.

14. The system of claim 1, wherein the RFID reader is ST25 NFC/RFID.

15. A food-ingredients-preparation-workstation (FIPW) that is associated with an automated-cooking-restaurant (ACR), the FIPW comprising:
an RFID read/write device;
a processing module; and
a non-transitory computer readable storage device comprising instructions that when are executed by the processing module cause the processing module to instruct an operator:
i. to prepare an ingredient according to a list-of-ingredients (LoI) and convert it into a prepared-ingredient;
ii. to place the prepared-ingredient in an FIC;
iii. to associate the FIC with the RFID read/write device of the FIPW for writing information about the prepared-ingredient into the RFID tag;
iv. to associate a certain conveying-mechanism (CoM) to the FIC that has the prepared-ingredient for generating a dispenser unit (DiU);
v. to associate the DiU with the RFID read/write device to read the RFID tag of the FIC and the RFID tag of the CoM and determine whether the CoM matches the requirements of the prepared-ingredients that are placed in the FIC and if the CoM matches the needs of the prepared-ingredients, then instruct the operator to place the DiU in the dispenser; if not instruct the operator to return to block (d) and replace the CoM.

16. The FIPW of claim 15, wherein the information about the prepared-ingredient that is written in the RFID tag of the FIC comprises at least one parameter from the group consisting of ingredient type, size, shape, amount, expiration date, allowable temperature range, and washing information.

17. The FIPW of claim 15, wherein the CoM matches the size of the prepared-ingredient.

18. The FIPW of claim 15, further comprising a communication module for communicating with an automated-cooking-restaurant (ACR).

19. The FIPW of claim 15, further comprising one or more accessories.

20. The FIPW of claim 19, wherein one of the accessories is a digital weight meter.
